(19) United States
(12) Patent Application Publication
(10) Pub. No.: US 2014/0058803 A1
(43) Pub. Date: Feb. 27, 2014

(54) System and Method for Evaluating Providers of Human Resources

(71) Applicants: James Humrichouse, Dallas, TX (US); Justin Junkel, Plano, TX (US); Mircea Negrea, Dallas, TX (US)

(72) Inventors: James Humrichouse, Dallas, TX (US); Justin Junkel, Plano, TX (US); Mircea Negrea, Dallas, TX (US)

(73) Assignee: PROVADE, INC., Milwaukee, WI (US)

(21) Appl. No.: 13/975,273

(22) Filed: Aug. 23, 2013

Related U.S. Application Data
(60) Provisional application No. 61/692,552, filed on Aug. 23, 2012.

(51) Int. Cl. G06Q 10/06

(52) U.S. Cl. CPC G06Q 10/06393
USPC 705/7.39

(57) ABSTRACT

A system and method for measuring the quality of candidates submitted for temporary positions by providers of contingent staffing solutions. More particularly, the invention relates to a method and system for recording various quality metrics for each step performed in the candidate selection process and indexes the recorded quality metrics to provide an evaluation of candidate quality over a given time period. A set of candidate quality factors and a set of candidate submission activities are defined and assigned various point values. Iterations of the sets over a predetermined time period are recorded and multiplied by the assigned point values to obtain a quality point total and activity point total. The quality and activity point totals are then correlated to obtain a quality index value which may be expressed in graph form to provide a measure of candidate quality over the predetermined time period.

### CROSS-REFERENCE TO RELATED APPLICATIONS

This application claims the benefit of U.S. Provisional Application No. 61/692,552, filed Aug. 23, 2012, which application is hereby incorporated herein by reference, in its entirety.

### FIELD OF INVENTION

The invention relates generally to a system and method for evaluating providers of human resources, or contingent staffing solutions, by measuring the quality of candidates they submit for temporary positions. More particularly, the invention relates to an automated method and system for evaluating providers of contingent staffing solutions by recording various quality metrics for each step performed in the selection process of candidates provided by a provider and for indexing the recorded quality metrics to provide an evaluation of the quality of candidates from a provider over a given time period.

### BACKGROUND OF THE INVENTION

Many companies use contingent workers to fill some of their human resource needs, also referred to as human capital needs, staffing needs, contingent workforce needs, and the like. Large companies often rely on a network of service providers to supply and manage their contingent workforce. The three main types of service providers are: 1) managed service providers (MSPs), which are outsourced managers of contingent workforce programs for companies; 2) staffing firms, which supply candidates directly to companies or to MSPs; and 3) vendor management systems (VMS) providers that supply software and services directly to companies or to MSPs to help manage contingent worker programs. Companies may have more than one MSP managing contingent workers at the same time, and each MSP may use a different VMS to manage its workers. Each company and/or MSP will have relationships with many staffing firms—sometimes hundreds of them.

Generally, the process for filling an open temporary position are: 1) a company or an MSP submits a requisition to its staffing firms for the open position, 2) staffing firms screen and submit candidates, 3) the company or MSP reviews submissions and requests interviews with candidates, 4) interviews with candidates are completed, 5) an offer is made to the chosen candidate, 6) an offer is accepted, and 7) the candidate begins work.

Due to the competitive nature of the staffing industry, it is necessary to be able to measure the quality of the services that are being provided by recruiters, staffing firms, and MSPs. There have been two general methods of measuring quality historically. The first is to measure the “fill ratio,” and the second is to assess the quality of workers after they begin working.

The “fill ratio” (also sometimes referred to as a “hiring ratio”) is widely-used to measure quality. It is simply the number of positions filled divided by the number of candidates submitted. The fill ratio may be used in a number of ways, such as to measure the effectiveness of an MSP in filling total positions for a contingent worker program, the effectiveness of a staffing firm in filling positions for a specific company or MSP, or even the effectiveness of a recruiter at a staffing firm in filling positions for a specific client or across all clients. Thus, if staffing firms supplying workers to the same MSP are compared, a staffing firm that has a higher “fill ratio” than another staffing firm is generally considered to provide better quality, as it is more often successful at filling an open position. The “fill ratio” method is limited, though, in its ability to measure candidate quality, because it uses only one data point (the ratio of submissions to filled positions) and relies on a winner take all method of assessing quality, and thus does not provide a robust picture of the candidate quality provided.

Assessment of contingent workers after they begin working is the other widely-used method of measuring quality. Generally, this method uses a survey tool that requests a manager to rate workers on different factors using a numeric scale, e.g. a scale of one to five (1 to 5), to measure how well a worker is performing on the job. If the workers provided by a staffing firm are rated higher on average than the workers provided by another staffing firm, it can be considered to be higher quality. This method is limited, though, because it only measures quality after a worker begins working, it does not measure candidate quality directly, and it relies on the subjective assessments of managers who fill out survey tools.

Both the “fill ratio” and the assessment of contingent workers after they begin working are intended to measure quality; however, neither adequately measures the quality of the most fundamental product or service provided in the staffing services industry—candidates.

Thus, there remains a need for a more robust method for measuring candidate quality, and for a readily understandable index of candidate quality that allows easy comparison between providers (e.g., recruiters, staffing firms, MSPs, or the like) over a period of time.

### SUMMARY OF THE INVENTION

Briefly stated, the present invention is a computer system and method for measuring and indexing the quality of candidates presented to fill open temporary positions, and for presenting the measurement and index in a readily understandable format that allows for comparison and evaluation of providers (e.g., recruiters, staffing firms, MSPs, or the like) over a period of time.

At its most basic, candidate quality is measured by comparing a provider's activity in a given period of time against outcomes. Activity is measured by assigning point values to the activities performed in the candidate submission process. The activities are weighted to reflect that certain activities have more value than others. Outcomes are measured by assigning point values to the accomplishment of certain steps or factors in the candidate selection process (interview request, interview completion, offer, acceptance), and aggregating the points within a given period of time.

By giving weight to each step in the candidate selection process, the present method and system avoids the winner take all methodology that only gives weight to hires without considering a provider's other desirable outcomes, such as interview requests and interview completions, which are also evidence of candidate quality.

Candidate quality may be measured by comparing a provider's quality points with the aggregate of the provider's activity and quality points. This value is then given a candidate quality index value based on the relationship between the two numbers and a set formula that expresses the ideal relationship between them. All three numbers (the quality points, activity points, and the candidate quality index value) may then be presented in a graph showing the relationship between activity and quality over time, the index value over time, and the number of full-time employees needed to achieve the outcomes presented. A higher quality index value is generally more desirable than a lower index value.

This method of assessing candidate quality, as well as the graphical representation of candidate quality over time in relation to the number of full-time employees needed to obtain the outcomes may be used independently, or it may be incorporated into a VMS, which would allow managers of contingent worker programs to be able to gather data easily from existing records to effectively assess the overall candidate quality of the program, the candidate quality of subsets of the program, and the candidate quality of specific staffing companies.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A is a block diagram exemplifying hardware effective for implementing features of the present invention;

FIG. 1B is a flow chart exemplifying the determination of an expected quality index in accordance with principles of the systems and method provided by the present invention;

FIG. 1C is a flow chart exemplifying the determination of an actual quality index in accordance with principles of the systems and method provided by the present invention;

FIG. 2 is a table exemplifying the calculation of an expected quality point total;

FIG. 3 is a table exemplifying the calculation of an expected activity point total;

FIG. 4 is chart exemplifying a sample quality index and the relationship between quality points, activity points, and the quality index over time;

FIG. 5 is chart exemplifying a sample quality index over time for positions that have an average bill rate of under $20.50;

FIG. 6 is chart exemplifying a sample quality index over time for positions that have an average bill rate of between $20.51 and $35.00;

FIG. 7 is chart exemplifying a sample quality index over time for positions that have an average bill rate of between $35.01-50.00;

FIG. 8 is a chart exemplifying a sample quality index over time for positions that have an average bill rate between $50.01-$60.00; and

FIG. 9 is a chart exemplifying a sample quality index over time for positions that have an average bill rate between $60.01-$70.00.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

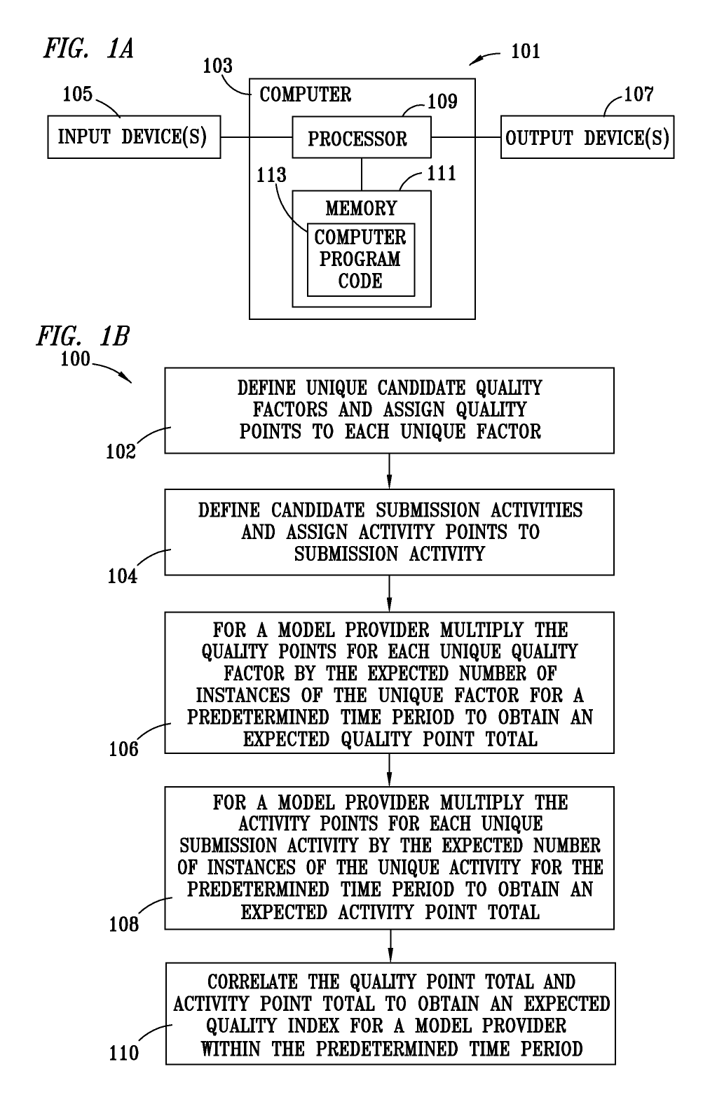

Referring to FIG. 1A of the drawings, the reference numeral 101 generally designates a computer system effective for implementing features of the present invention. The system 101 includes a computer 103 coupled to one or more input devices (e.g., keyboard, mouse, and the like) 105 and one or more output devices (e.g., display, printer, and the like) 107. The computer 103 preferably includes at least a processor 109 and memory 111. The memory 111 is effective for storing computer program code 113 executable by the processor 109 for performing features of the invention. The computer program code 113 is preferably effective for executing steps described in further detail below with respect to FIGS. 1B and 1C.

Referring to FIG. 1B, there is shown a flow chart 100 of one preferred embodiment of the computer system and method provided by the present invention. As previously discussed, the present system and method is suitable for use in a computer executable software, and preferably in a VMS. At step 102, a set of unique candidate quality factors is defined and varying quality points are assigned to each unique factor. For example, factors that may be defined for measuring candidate quality may include a factor for the number of interviews requested by a company, the number of interviews completed by the company, the number of job offers extended to candidates by the company, and the number of offer acceptances by the candidates. Another factor that may be defined includes fall-off, which may be defined as candidates who have accepted a job offer but later do not begin work for the company, or begin work and leave the company after a short time period; for instance, a candidate who begins work and leaves the company within two weeks of starting.

After the quality factors have been determined, each factor is assigned a point value. For example, interviews requested may be assigned a point value of four (4); interviews completed may be assigned a point value of five (5); offers extended may receive a point value of five (5); and offers accepted may receive a point value of six (6). It is noted that the sum of points when there is an acceptance is 4+5+5+6=20 which equates to one FTE. The fall-off factor, which represents a negative factor, may receive a point value of negative twenty (−20). Thus, the point values assigned to the various quality factors generally correlate to the expected proportion of occurrences of a given factor occurring during the hiring process. Naturally, during the hiring process, the number of interviews completed will always be less than or equal to the number of interviews requested, the number of offers extended will always be less than or equal to the number of interviews completed, and the number of offers accepted will always be less than or equal to the number of offers extended.

Thus, because the interviews requested factor will always be the most prevalent, that particular factor is assigned a lower point value than factors that will logically occur less. In this fashion, quality factors that respectively occur less are correspondingly assigned greater point values to emphasize the desirability of that factor. Furthermore, the relative differences between the assigned point values further illustrate the relative occurrence of each quality factor. For instance, under the present embodiment described, the ratio of point values assigned to interviews completed to interviews requested is four to five (4:5), and is attributable to historical staffing industry data wherein the number of interviews completed is roughly eighty percent (80%) of the interviews requested.

In addition, because fall-off will be particularly detrimental to the measure of candidate quality, the negative point value assigned may reflect a complete loss of the accumulated quality points for the given candidate. Thus, under the embodiment illustrated, fall-off factor is assigned a point value of negative twenty (−20), which essentially wipes out the sum of all positive point values for the candidates (4+5+5+6=20).

At step 104, candidate submission activities are defined and activity points are assigned to each submission activity. Under the present embodiment, candidate submission activities that are related to candidate quality may be defined as unique resumes submitted and resubmitted resumes. Unique resumes are those resumes that have not been submitted more than once to the same company within a given time period, such as a four week interval. Resubmitted resumes are thus those resumes that have been submitted more than once to the same company within the given time period. Unique submits may be assigned a point value of two (2) points, to emphasize the greater amount of activity required to submit a unique candidate to the company. Resubmits may be assigned a point value of one (1) point, as less overall activity is required to resubmit a candidate to the same company. It is understood that if a resume is resubmitted one or more times, no more than one acceptance may result from it.

Next, at step 106, the number of occurrences or instances resulting from action by a model provider for each defined quality factor within a given time period are multiplied together. For example, in a time period of one week, a client company may have four (4) interview requests. Thus, the point value of four (4) for interviews requested is multiplied by the four (4) occurrences, yielding sixteen (16) quality points. The interviews completed quality factor may have three (3) occurrences, in which case the point value of five (5) for interviews completed is multiplied by three (3), yielding fifteen (15) quality points. The remaining quality factors are likewise multiplied together. The total for each quality factor is then summed together to obtain the overall quality point total for the given time period of one week.

At step 108, the activity points or instances resulting from action by a model provider are also tabulated for a given time period, such as a week. To do so, the number of unique submits for the time period are multiplied by the assigned point value of two (2) points, to yield a product for unique submits. The number of resubmits are multiplied by a the assigned point value of one (1) point, to yield a product for resubmits. The product totals for unique submits and resubmits are then summed together to obtain the overall activity point total for the given time period of one week.

Continuing, at step 110, the quality point total and the activity point total are correlated together to obtain a quality index for the predetermined time period, exemplified herein as one week. This correlated quality index number is a measure of the candidate quality a model provider or group of model providers provides to a company during the predetermined time period. The quality index number may then be used to more accurately provide a relatable measure of the candidate quality a company is receiving. However, such a quality index number is less useful without comparison to a reference, or expected, quality index number, discussed below with respect to FIG. 1B.

Turning to FIG. 1C, an actual quality index is calculated for an actual provider in a manner similar to the calculation of the expected quality index calculated in accordance with the steps of FIG. 1A for a model provider. Accordingly, at step 122, an actual quality point total is obtained by multiplying the quality points for each unique quality factor by the actual number of instances of the quality factor resulting from action by an actual provider for a predetermined time period, such as a week. Similarly, at step 124, an actual activity point total is obtained by multiplying the activity points for each candidate submission activity by the actual number of instances of the candidate submission activity resulting from action by an actual provider for a predetermined time period.

At step 126, the actual quality point total calculated at step 122 is correlated with the actual activity point total calculated at step 124 to obtain an actual quality index for the actual provider with the predetermined period of time, such as a week.

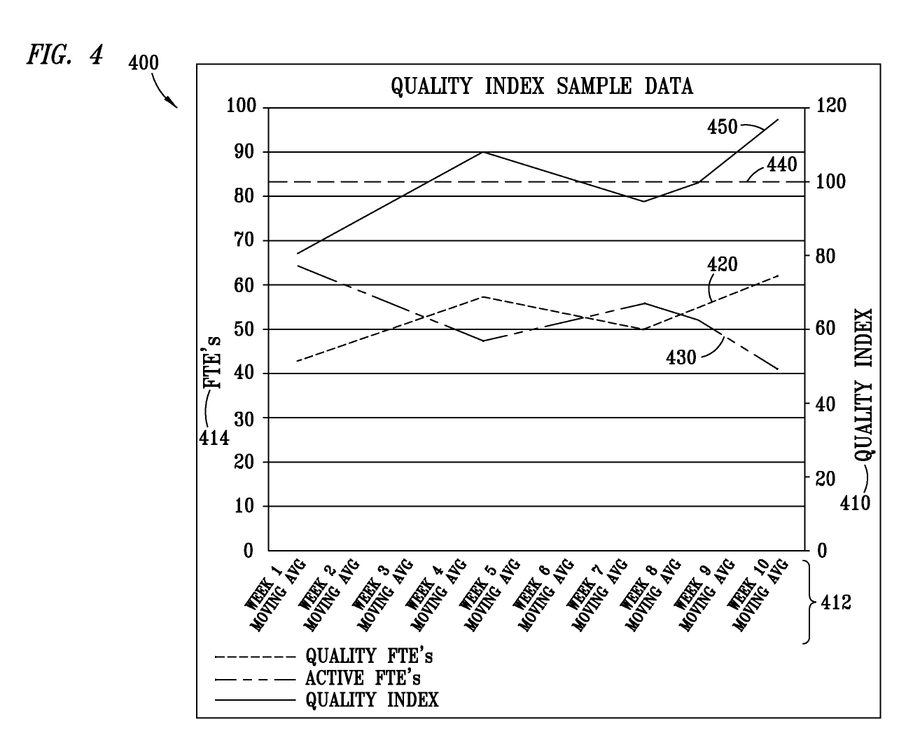

In step 128, the actual quality index calculated in step 126 is compared to the expected quality index to determine if the provider is or is not meeting expectations, or is exceeding expectations. The particulars of such calculations are discussed in further detail below with respect to FIG. 4. While it may generally suffice to calculate the expected quality index in accordance with steps 102-110 of FIG. 1B only once, the actual quality index calculated in accordance with steps 122-128 is preferably repeated for each provider for each period of time (e.g., week) of interest.

It may be appreciated that the expected quality index number provides a useful reference point or a baseline performance standard against which an actual quality index number may be compared. In this fashion, a user of the computer system or method provided by the present invention, such as the company or an MSP, may be able readily to see and understand the actual candidate quality being provided by a provider, and whether the quality of candidates provided by the provider is at a satisfactory, expected level or is above or below that standard of expectation.

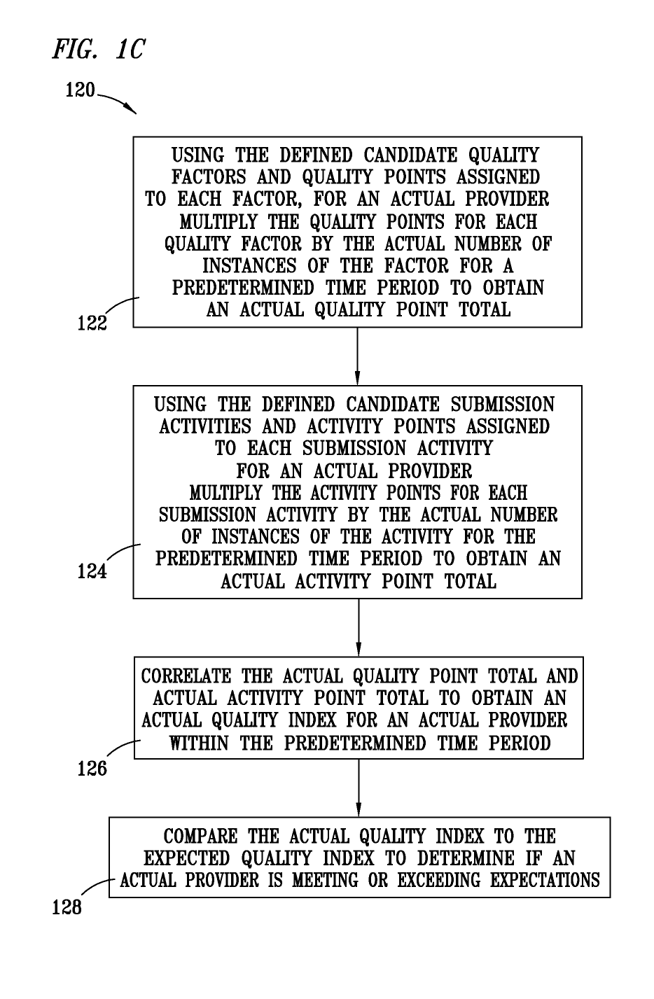

Turning next to FIG. 2, therein is shown a table 200 resulting from the calculation of an expected quality point total in accordance with FIG. 1A. While table 200 is illustrative of how an expected quality point total may be calculated, a similar table may be established for recording and calculating actual quality points based upon the five quality factors shown. In table 200, the first column 202 comprises various quality factors, which are the previously described interview requests, interview completions, offers, acceptances, and falloffs. In the second column 204, each unique quality factor has been assigned a point value, with interview requests receiving a value of four (4), interview completions receiving a value of five (5), job offers made receiving a value of five (5), offer acceptances receiving a value of six (6), and falloffs receiving a value of negative twenty (−20). The third column 206 represents the expected number of iterations for a given quality factor in a predetermined time period. In the example shown in table 200, a time period of one week is used. The fourth column 208 of table 200 is then calculated by multiplying the point value for a unique quality factor by the expected number of iterations in a week, providing a quality point total for each quality factor.

Under the example given in table 200, the values given in the third column illustrate that for a given week, it is expected that the candidates provided to client companies by a single recruiter may generate four (4) interview requests, three (3) interview completions, one (1) offer, and one (1) acceptance, with no fall-offs. The quality point totals are then summed together to provide an overall quality point total for the week. In the example shown, the overall quality point total is forty-two (42) points, which represents the expected number of quality points generated by one full-time employee in a one week period.

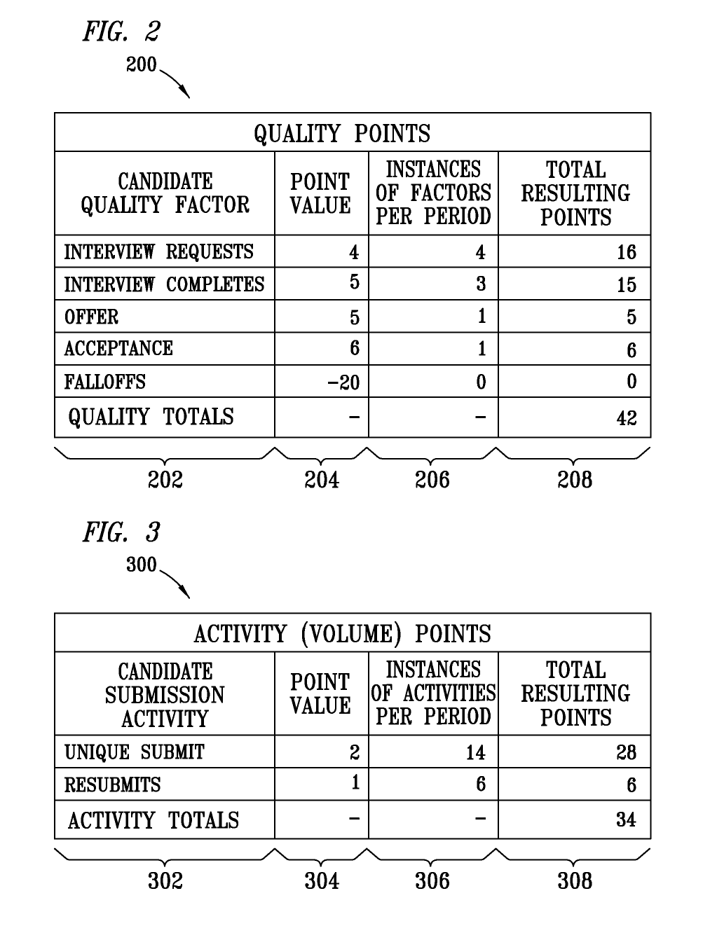

Next, at FIG. 3, a table 300 is shown which illustrates how an expected activity point total is calculated. As with table 200, while table 300 shows how an expected activity point total may be calculated, a similar table may be used for recording and calculating actual activity point totals based upon the number of unique submits and resubmits. The first column comprises the activity factors, such as unique submits and resubmits. The second column of table 300 lists the number of activity points for each type of activity factor, with unique submits receiving a point value of two (2) points and resubmits receiving a point value of one (1) point. The third column represents the expected number of iterations for a given activity factor in a week, and is based upon the same predetermined time period set in table 200. In table 300, it is expected that one full-time employee will generate fourteen (14) unique submits and six (6) resubmits in a given week. The fourth column of table 300 is then computed in similar fashion to the fourth column of table 200, resulting in twenty-eight (28) points for the unique submits and six (6) points for the resubmits, or an expected activity point total of thirty-four (34). Thus, reading tables 200 and 300 together, one full-time employee may be expected to generate a quality point total of 42 based upon an activity point total of 34.

As tables 200 and 300 represent expected iterations of quality factors and activity factors for a given week, actual performance may vary from the numbers given. Thus, an employee may provide more or less than fourteen (14) unique submits and six (6) resubmits shown in table 300, so long as the employee provides a combination of unique submits and resubmits, which results in an activity point total of thirty-four (34). Similarly, the number of interview requests, interviews completed, offers, acceptances and fall-offs may also vary from the expected numbers provided in table 200, so long as the combination of the unique quality factors yields a point total of forty-two (42).

The expected quality point total and activity point total may then be correlated to obtain an expected quality index. The expected quality index is preferably computed by comparing the quality point total to the aggregate of the quality point and activity point totals. That is, generally, if I=quality index, q=total quality points, and a=total activity points, then in a preferred embodiment, I=q/(q+a). Similarly, the expected quality index would generally be Iₑ=qₑ/(qₑ+aₑ).

In the example illustrated by tables 200 and 300, qₑ=42 and aₑ=34. Then Iₑ=qₑ/(qₑ+aₑ)=42/(42+34)˜0.55. Under the system and method provided by the present invention, this index would be set to be equivalent to one hundred (100) on a quality index scale. Thus, a quality index score of one hundred (100) would be the expected level of quality generated by one full-time employee within a one week period. In other words, when the quality index is exactly one hundred (100), the provider is meeting expectations. By comparing actual performance to the index score of one hundred (100), the candidate quality being provided may be readily assessed and corrective measures taken, if necessary. To further illustrate, by way of example but not limitation:

Regarding the Quality Index:
I=Observed Quality Index
Iₑ=Expected Quality Index Value
I_{b}=Expected Quality Index Baseline
z=Index Factor (sets Iₑ=100)
Iₐ=Actual Quality Index Value

Regarding the Expected Quality Index Calculation:
qₑ=42
aₑ=34

Iₑ=qₑ/(aₑ+qₑ)=42/(34+42)=42/76˜0.5526

I_{b}=100=Iₑ*z=Iₑ*100/(44/76)=100*Iₑ/Iₑ=100

z=100/Iₑ=100/0.5526˜181

Regarding the Actual Quality Index Calculation:

I=q/(a+q)

Iₐ=I*z
q=45
a=34
I_{b}=100
z˜181

I=45/(34+45)=45/79˜0.57

Iₐ=I*z=0.57*181˜103

Turning to FIGS. 4-9, it is noted that each of FIGS. 4-9 actually comprises two charts superimposed on each other, both sharing the same horizontal (“x”) axis, but with one using the left vertical (“y”) axis and the other using the right vertical (“y”) axis. More specifically, one chart includes two lower lines defined by the horizontal (“x”) axis delineating time (e.g., weeks), and the left vertical (“y”) axis delineating FTEs. One of the lower lines depicts FTE's that correlate quality points, and the other of the lower lines depicts FTE's that correlate to activity points. The other chart includes two upper lines defined by the horizontal (“x”) axis delineating time, and the right vertical (“y”) axis delineating quality points. One of the upper lines is horizontally flat and correlates to an expected quality index, and the other of the upper lines correlates to an actual quality index. In an alternative embodiment of the invention, the left and right vertical (“y”) axes may be reversed, and the relative positions of the upper and lower lines may be reversed.

With respect to FIG. 4, a chart 400 is exemplified which depicts a sample quality index for a provider over a predetermined time period. Chart 400 provides an illustration of the relationship between quality points, activity points and the quality index over a set period of time and in relation to the number of full-time employees that would be expected to generate the illustrated results. Within chart 400, there are simultaneous plots for the number of quality points and activity points, represented relative to full time employees (FTEs) 414 on the left-hand y-axis, the measured time period 412 for the overall graph on the x-axis, and the quality index 410 on the right-hand y-axis. A quality line 420 represents the number of actual quality points generated over the given time period divided by the number of expected quality points one FTE would be expected to generate in the same time period 412 (i.e., FTE's=qₐ/qₑ). An activity line 430 represents the number of activity points generated over the given time period divided by the number of activity points one FTE would be expected to generate in the same time period 412. In chart 400, quality line 420 and activity line 430 are both charted relative to FTEs 414 needed to generate the activity and quality outcomes in the given time period 412. Thus, it can be readily determined where quality line 420 exceeded the activity line 430, and vice versa, directly correlating to the amount of quality per FTE being provided for the amount of activity per FTE in a given time period 412.

The quality line 420 and activity line 430 are preferably correlated to provide a quality index line 450, and the resultant quality index line 450 may be readily compared to the expected quality index line 440. Quality index line 450 illustrates a ratio of FTE's based on quality over FTE's based on activity. Over time, it is preferred that the performance for the client company will result in an upward trend of quality index line 450, which may indicate that quality is improving or increasing. A downward trend of quality index line 450 would thus be undesirable, as it would generally indicate declining quality of the candidates being provided. In chart 400, expected quality index line 440 has been set to a quality index of 100, as can be seen on the right-hand y-axis 410, and has been calculated according to the methods shown in FIGS. 2-3. The actual quality index line 450 may then be graphed based upon the values provided by quality line 420 and activity line 430. The quality index line 450 will increase relative to the difference between the quality line 420 and the activity line 430. So, as both lines trend upward or downward proportionally, the quality index line 450 will remain the same. When the relationship between the quality line 420 and the activity line 430 become disproportionate, the quality index line 450 will correspondingly change. If the quality line 420 increases disproportionately to the activity line 430, the quality index line 450 will increase. If the quality line 420 decreases disproportionately to the activity line 430, the quality index line 450 will decrease. Once graphed, quality index line 450 then provides a more robust representation of the candidate quality being provided.

In the sample quality index illustrated by chart 400, it can be seen that where quality line 420 has increased disproportionately to the activity line 430, the actual quality index line 450 has also increased in reference to expected quality index line 440. This represents the scenario where the amount of quality that a client company is getting is greater than what is to be expected for the given time period. In cases where activity line 430 has a disproportionately greater value than quality line 420, the actual quality index line 450 is below the expected quality index line 440. This therefore represents the scenario where the client company is receiving less quality than is to be expected for the given time period. Where the quality line 420 and activity line 430 intersect, this represents the scenario where the relationship between the amount of quality being provided matches the amount of activity generated. Thus, at the points of intersection of quality line 420 and activity line 430, the actual quality index line 450 also intersects the expected quality index line 440, meaning that the actual amount of quality being provided is perfectly aligned with the expected amount of quality.

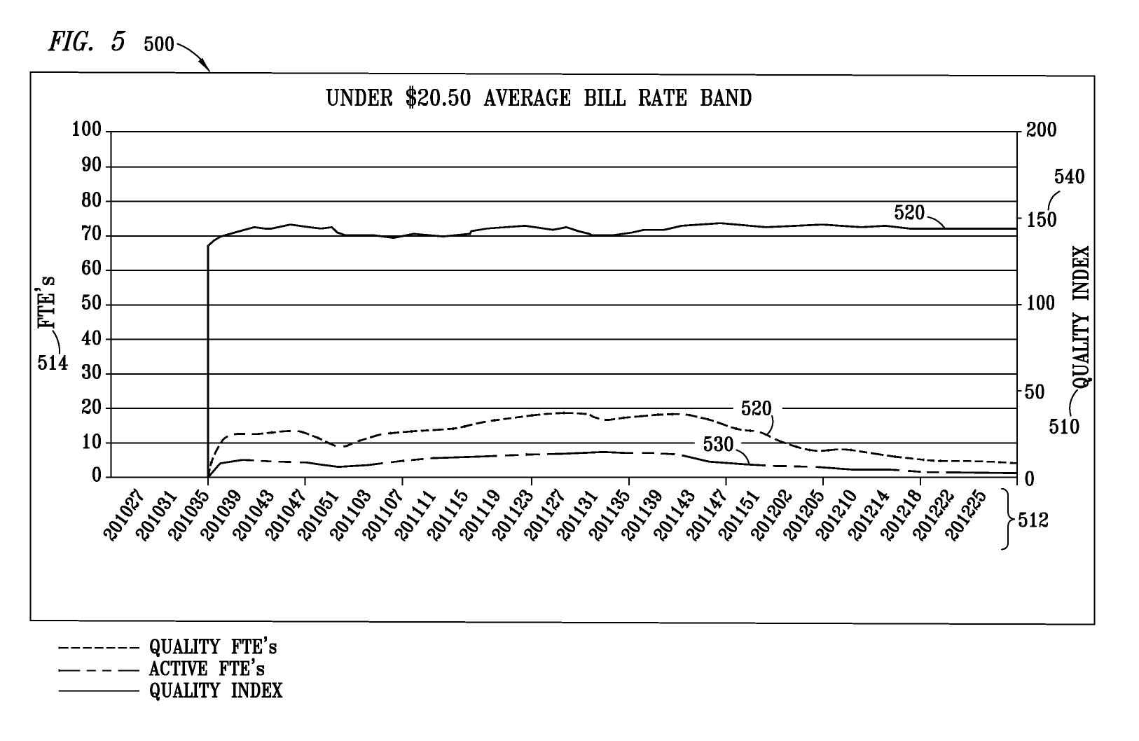

Turning next to FIG. 5, a sample quality index chart 500 wherein positions that have an average bill rate of less than $20.50 is shown. In the embodiments of the invention illustrated in FIGS. 2-4, the expected quality index score of 100 represents the expected amount of quality in relation to the expected amount of activity. However, the expected quality index score may be adjusted upward or downward depending on the bill rate of the positions that a company is trying to fill. Other considerations may also impact the adjustment of the expected quality index score. In particular, the bill rate of a position to be filled will have an impact on the quality index scores, as lower bill rate positions typically will have a greater number of quality points attributable to a given amount of activity points than higher bill rate positions. The effect that bill rate has on quality points is due primarily to the higher number of iterations for the previously defined unique quality factors during a given time period. That is, for a one week time period, a lower bill rate position will likely have a higher percentage of interviews requested, interviews completed, offers, and acceptances for a given number of candidates submitted, than a higher bill rate position. While a number of reasons may be attributable to the discrepancy between relatively low bill rate positions and high bill rate positions, the primary reasons may be that clients tend to become more selective in their candidate selection for relatively high bill rate positions, and that individuals qualified to fill these positions are scarcer.

Remaining on FIG. 5, chart 500 illustrates a band of relatively low bill rate positions. As with chart 400, chart 500 provides for illustration of the relationship between quality points, activity points and the quality index over a set period of time and in relation to the number of full-time employees would be expected to generate the illustrated results. Within chart 500, there are simultaneous plots for the number of quality points and activity points, represented relative to FTEs 514 on the left-hand y-axis, the measured time period 512 (exemplified in year week format) for the overall graph on the x-axis, and the quality index 510 on the right-hand y-axis. A quality line 520 represents the number of quality points generated over the given time period divided by the number of quality points one FTE would be expected to generate in the same time period 512. An activity line 530 represents the number of activity points generated over the given time period divided by the number of activity points one FTE would be expected to generate in the same time period 512. In chart 500, quality line 520 and activity line 530 are both charted relative to FTEs 514 needed to generate the activity and quality outcomes in the given time period 512. As can be seen on chart 500, actual quality index line 550 maintains a quality index score of roughly 150. As a result, based upon the ideal quality index score of 100, it would appear that the candidate quality being provided in chart 500 is of significantly high quality.

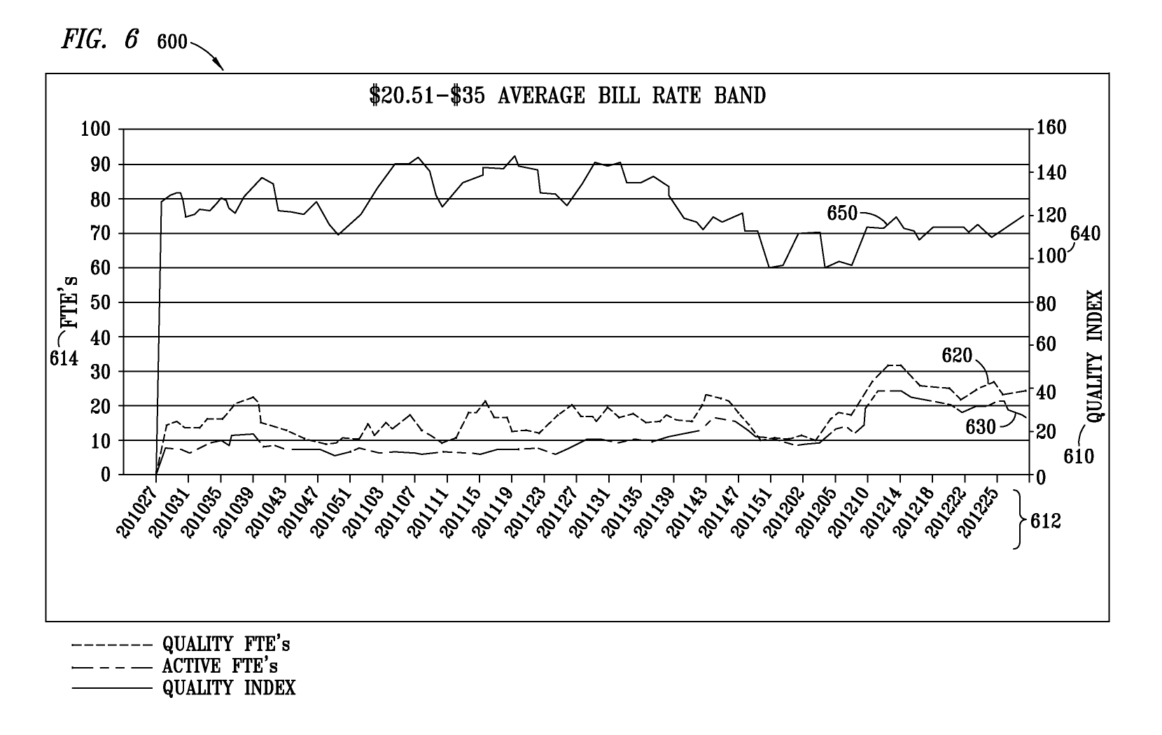

However, as discussed above, the quality index score shown in chart 500 may be impacted by the bill rate of the position being filled, and it can be helpful as a result to consider bill rates within certain ranges in separate “bill rate bands” to further understand the quality provided. Thus, for the quality index being graphed by chart 500, an expected quality index score of 100 may be too low to accurately capture what an ideal or expected quality index should be for that bill rate band. Rather, for the given bill rate band being evaluated, it may be desirable to reset the expected quality index score to a number that makes more sense in the given context, such as 150, which accounts for the anticipated impact the lower bill rate will have on the relationship between quality points and activity points generated for each FTE. In other words, less activity is expected to be required to generate quality outcomes. Turning to FIG. 6, a chart 600 illustrates a sample quality index graph for positions in a bill rate band with bill rates between $20.51 and $35.00. As with charts 400 and 500, chart 600 provides for illustration of the relationship between quality points, activity points and the quality index over a set period of time and in relation to the number of full-time employees would be expected to generate the illustrated results. Within chart 600, there are simultaneous plots for the number of quality points and activity points, represented relative to FTEs 614 on the left-hand y-axis, the measured time period 612 for the overall graph on the x-axis, and the quality index 610 on the right-hand y-axis. A quality line 620 represents the number of quality points generated over the given time period divided by the number of quality points one FTE would be expected to generate in the same time period 612. An activity line 630 represents the number of activity points generated over the given time period divided by the number of activity points one FTE would be expected to generate in the same time period 612. In chart 600, quality line 620 and activity line 630 are both charted relative to FTEs 614 needed to generate the activity and quality outcomes in the given time period 612. As in chart 500, the quality index 650 graphed in chart 600 is consistently above the expected quality index line 640 of 100, although it is not as high as the quality index 550 graphed in chart 500. This demonstrates that for the bill rate band presented in chart 600, providers should expect the quality index to be consistently over 100, but not as high as 150, as in chart 500.

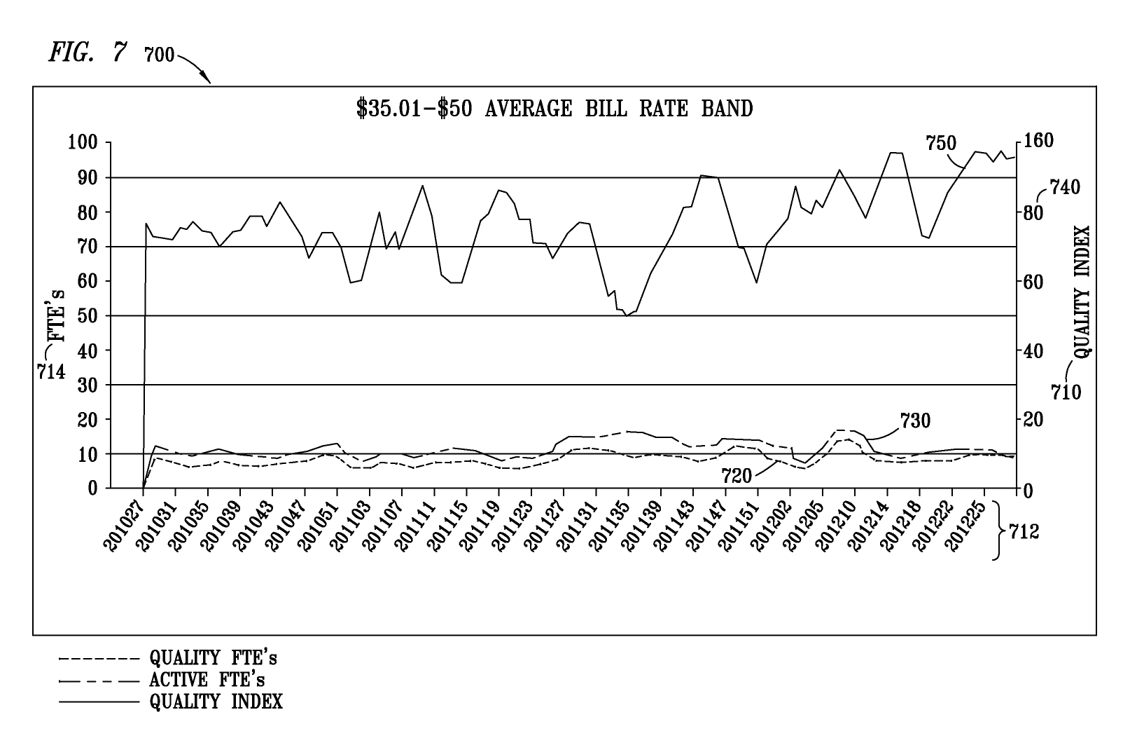

Next, at FIG. 7, a chart 700 illustrates a sample quality index graph for positions that have an average bill between $35.01 and $50.00. Chart 700 provides for illustration of the relationship between quality points, activity points and the quality index over a set period of time and in relation to the number of full-time employees would be expected to generate the illustrated results. Within chart 700, there are simultaneous plots for the number of quality points and activity points, represented relative to FTEs 714 on the left-hand y-axis, the measured time period 712 for the overall graph on the x-axis, and the quality index 710 on the right-hand y-axis. A quality line 720 represents the number of quality points generated over the given time period divided by the number of quality points one FTE would be expected to generate in the same time period 712. An activity line 730 represents the number of activity points generated over the given time period divided by the number of activity points one FTE would be expected to generate in the same time period 712. In chart 700, quality line 720 and activity line 730 are both charted relative to FTEs 714 needed to generate the activity and quality outcomes in the given time period 712. Because the bill rate band for this graph 700 is higher than those shown in graphs 500 and 600, the quality index 750 is lower.

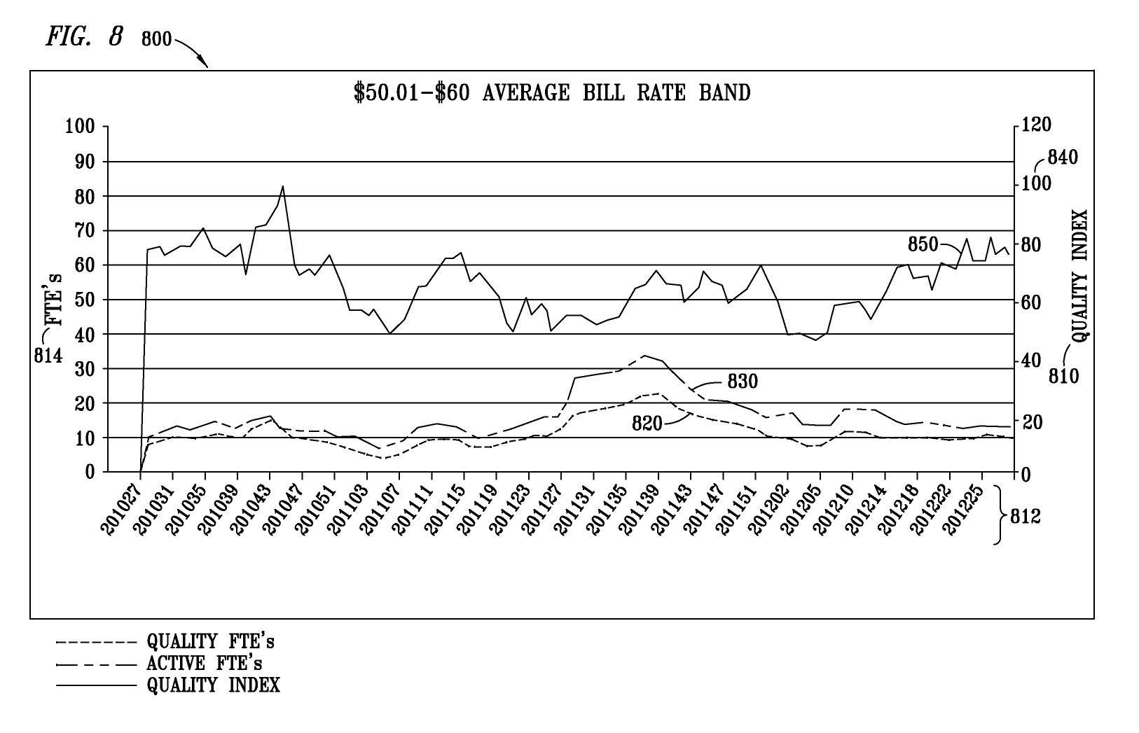

At FIG. 8, a chart 800 illustrates a sample quality index graph for positions that have an average bill between $50.01 and $60.00. Chart 800 provides for illustration of the relationship between quality points, activity points and the quality index over a set period of time and in relation to the number of full-time employees would be expected to generate the illustrated results. Within chart 800, there are simultaneous plots for the number of quality points and activity points, represented relative to FTEs 814 on the left-hand y-axis, the measured time period 812 for the overall graph on the x-axis, and the quality index 810 on the right-hand y-axis. A quality line 820 represents the number of quality points generated over the given time period divided by the number of quality points one FTE would be expected to generate in the same time period 812. An activity line 830 represents the number of activity points generated over the given time period divided by the number of activity points one FTE would be expected to generate in the same time period 812. In chart 800, quality line 820 and activity line 830 are both charted relative to FTEs 814 needed to generate the activity and quality outcomes in the given time period 812. Because the bill rate band for the chart 800 is even higher than those shown in graphs 500, 600 and 700, the quality index 850 is expectedly lower than each of the previously described charts.

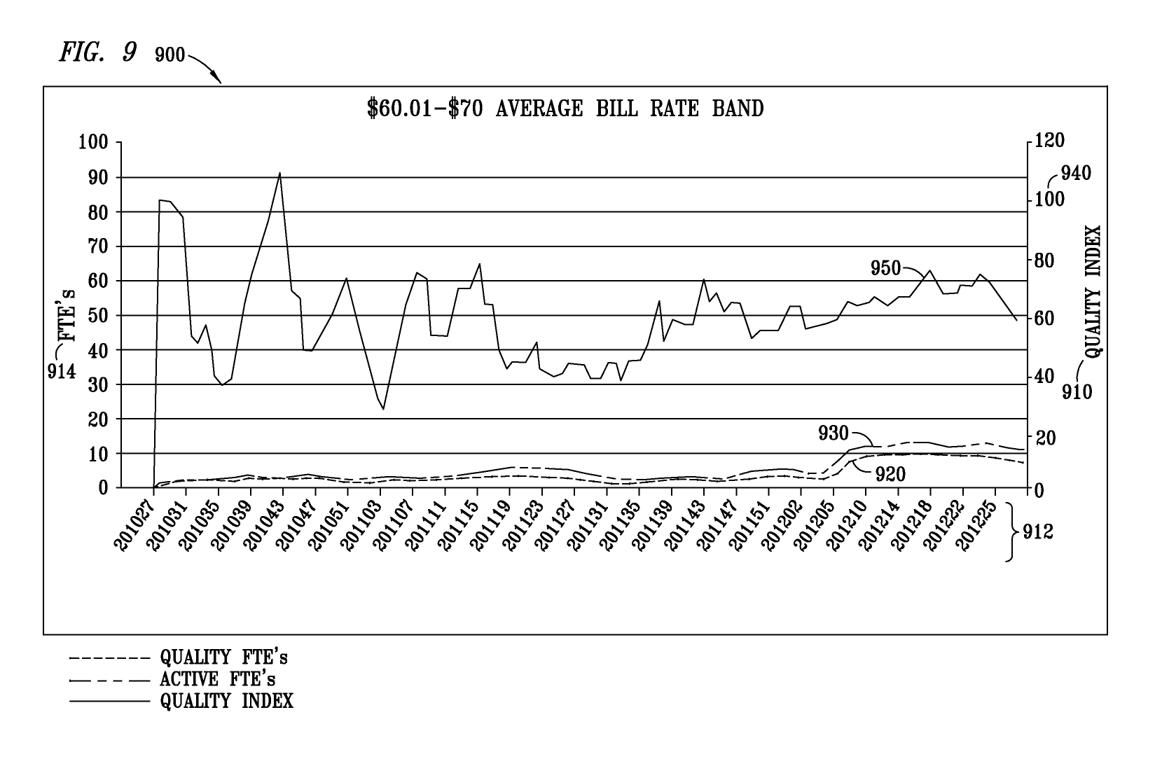

Turning to FIG. 9, a chart 900 illustrates a sample quality index graph for positions that have an average bill between $60.01 and $70.00. Chart 900 provides for illustration of the relationship between quality points, activity points and the quality index over a set period of time and in relation to the number of full-time employees would be expected to generate the illustrated results. Within chart 900, there are simultaneous plots for the number of quality points and activity points, represented relative to FTEs 914 on the left-hand y-axis, the measured time period 912 for the overall graph on the x-axis, and the quality index 910 on the right-hand y-axis. A quality line 920 represents the number of quality points generated over the given time period divided by the number of quality points one FTE would be expected to generate in the same time period 912. An activity line 930 represents the number of activity points generated over the given time period divided by the number of activity points one FTE would be expected to generate in the same time period 912. Within chart 900, quality line 920 and activity line 930 are both charted relative to FTEs 914 needed to generate the activity and quality outcomes in the given time period 912. As the bill rate band for the chart 900 is even higher than those shown in graphs 500, 600, 700, and 800, the quality index 950 is accordingly lower than each of the previously described charts.

As can be seen by the various differing bill rates shown in charts 500, 600, 700, 800, and 900, different average bill rates will cause the quality index lines to naturally adjust into different “bands,” with higher bill rates typically corresponding with lower quality index values and lower bill rates corresponding with higher quality index values. Thus, the present invention allows for a more concise feedback measure of quality, as overall data can be subdivided by bill rate band to provide a better understanding of trends within a contingent worker program.

Furthermore, at times a client company may decide to adjust the bill rates for certain positions. By utilizing the present invention, the client may be able to determine whether the change in bill rate would likely have a positive or negative impact on candidate quality. For instance, a lowering of the bill rate for a position to be filled may result in a downward trend of candidate quality. Or the change in bill rate may not significantly affect candidate quality. Regardless of the outcome, the present system and method provides a more complete and thorough approach to measuring candidate quality.

The quality index may also be used to evaluate the number of FTEs required to achieve a given level of candidate quality. By utilizing the present invention, a company, MSP, or staffing firm can evaluate whether reducing or adding to its FTEs would be expected to have a positive or negative impact on candidate quality. For example, if candidate quality is high relative to FTEs, it may be possible to reduce the FTEs and still maintain an acceptable quality level. If candidate quality is low relative to FTEs, personnel changes may be indicated.

In addition, the benefits of the invention in providing a graphical illustration of quality over time include not only the ability to measure an individual provider's performance in providing quality candidates, but also the total amount of quality being provided to each contingent staffing program, whether run by an MSP or a company directly. That is, by reviewing the quality index graphs for a given period of time, certain trends or considerations may become evident for the client, and the client may be able to make certain predictions or forecasts from the trends. For instance, graphing the actual quality index for a client over a period of time may show increasing or decreasing quality trends for the client, which will allow it to respond by changing its bill rate for certain positions or by adding additional FTEs. If quality is consistently higher than expected, it may be possible to lower the bill rate or the number of FTEs. If quality is consistently lower than expected, it may be necessary to raise the bill rate or add FTEs or make personnel changes. Likewise, if certain provider's consistently provide less quality than their peers, a client may decide to eliminate certain providers from its program, or increase its use of ones that consistently provide higher quality.

This method of assessing candidate quality, as well as the graphical representation of candidate quality over time in relation to the number of full-time employees needed to obtain the outcomes can be used independently, or it can be incorporated into a VMS, which would allow managers of contingent worker programs to be able to rely on already-existing data to effectively assess the overall candidate quality of the program, the candidate quality of subsets of the program, and the candidate quality of specific staffing companies.

It is understood that the present invention may take many forms and embodiments. Accordingly, several variations may be made in the foregoing without departing from the spirit or the scope of the invention. For example, in FIGS. 5-9, the expected quality index baseline I_{b} may be maintained at 100 even if the expected instances of factors and activities in FIGS. 2 and 3 are adjusted. The factors and activities in FIGS. 2 and 3 may be adjusted to reflect different expected values for different bill rates or industry sectors or other variables. Likewise, the baseline I_{b} may be set at a value other than 100.

It will be readily apparent to those skilled in the art that the general principles defined herein may be applied to other embodiments and applications without departing from the spirit and scope of the present invention. Having thus described the exemplary embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. In particular, variations of the present invention may include the use of other quality activity factors related to the hiring process, and are not limited to the factors articulated herein. Accordingly, it is contemplated that the appended claims will cover any such modifications or embodiments that fall within the true scope of the invention.

What is claimed is:

1. A method for measuring candidate quality provided to a company, the method comprising the steps of:
defining a set of candidate quality factors and assigning quality point values to each unique quality factor within the set;
defining a set of candidate submission activities and assigning activity point values to each unique candidate submission activity within the set;
recording a number of iterations for the set of candidate quality factors over a predetermined time period and multiplying the number of iterations by the assigned quality point value for each unique quality factor to obtain a quality point subtotal for each unique quality factor;
recording a number of iterations for the set of candidate submission activities over the predetermined time period and multiplying the number of iterations by the assigned activity point value for each unique candidate submission activity to obtain an activity point subtotal for each unique candidate submission activity;
aggregating the quality point subtotals and candidate submission activity subtotals to obtain a respective quality point total and an activity point total;
correlating the quality point total and activity point total to obtain a quality index value; and
comparing the quality index value to an expected quality index value.

2. The method of claim 1 further comprising the step of:
presenting the quality point total, activity point total, quality index value, and expected quality index value graphically over the predetermined period of time and relative to a number of full-time employees needed to obtain the results.

3. The method of claim 1 wherein the step of correlating the quality point total and activity point total to obtain a quality index value is performed on a computer system.

4. A computer-based system for measuring candidate quality provided to a company, the system comprising:
a set of candidate quality factors, the set having a quality point value assigned to each unique quality factor within the set;
a set of candidate submission activities, the set having an activity point value assigned to each unique submission activity within the set;
a recorded number of iterations for the set of candidate quality factors over a predetermined time period, the recorded number of iterations multiplied by the assigned quality point value for each unique quality factor to obtain a quality point subtotal for each unique quality factor;
a recorded number of iterations for the set of candidate submission activities over the predetermined time period, the recorded number of iterations multiplied by the assigned activity point value for each unique submission activity to obtain an activity point subtotal for each unique submission activity;
wherein the quality point subtotals and candidate submission activity subtotals are aggregated to obtain a respective quality point total and an activity point total; and
wherein the quality point total and activity point total are correlated to obtain a quality index value.

5. The system of claim 4, wherein the quality index value is compared to an expected quality index value.

6. The system of claim 4, wherein an expected quality index value, the quality index value, the quality point total, and the activity point total are represented graphically over the predetermined time period and relative to a number of full-time employees needed to obtain the results.
